(19) United States
(12) Patent Application Publication
(10) Pub. No.: US 2011/0096007 A1
(43) Pub. Date: Apr. 28, 2011

(54) OPERATION PROCESSING SYSTEM, OPERATION PROCESSING METHOD AND OPERATION PROCESSING PROGRAM

(75) Inventors: Katsuhide KITAGAWA, Hitachinaka (JP); Junichi Suzuki, Hitachiota (JP); Yoshio Maruyama, Mito (JP)

(73) Assignee: Hitachi Ltd.

(21) Appl. No.: 12/905,201

(22) Filed: Oct. 15, 2010

(30) Foreign Application Priority Data
Oct. 23, 2009 (JP) 2009-244178

(51) Int. Cl. G06F 3/041

(52) U.S. Cl. 345/173

(57) ABSTRACT

An operation processing system capable of attaining operation inputting to a touch panel device fast with high security, in which upon receiving finger image data imaged by the touch panel device with position information of a finger area detected by a point detection part taken as an imaging range form the touch panel device, an authentication part in the operation processing system authenticates the received finger image data, and when the authentication conducted by the authentication part has succeeded, an operation processing part acquires an operation to the operation object located in position information detected by the point detection unit from a control table of operation authentication and outputs the operation.

### BACKGROUND OF THE INVENTION

The present invention relates to techniques of an operation processing system, an operation processing method and an operation processing program.

A touch panel device has two functions, i.e., a display function and an input function on the same screen, and it is spread as an intuitive user interface.

In the display function, image information received from the outside such as a computer is displayed on a liquid crystal display or the like.

In the input function, the operator touches a point or an area such as a picture or a pictogram (pictograph) displayed on the screen with a hand or applies pressure on the point or the area with a dedicated pen called “stylus” or an ordinary pen, and consequently information of the touched screen position is sensed and output to the outside as an information signal. Upon receiving the information signal which is output, an external apparatus executes a suitable operation desired by the operator on the basis of the position information on the screen.

As for the position information, only one point has been detected until now. However, a touch panel having a multi-touch screen capable of detecting a plurality of points has appeared, and further improvement of the operation ability is being groped for.

By the way, an authentication system for authenticating an operator who inputs operation is introduced to enhance the security in some cases.

In Patent Document 1, an authentication system utilizing an imaging equipment having a display function is disclosed. This imaging equipment is a thin-type imaging equipment in which a display part, a light source and an imaging part are formed as one body. And a finger vein authentication system which images finger veins via a dedicated imaging window is used as the authentication system in Patent Document 1. This finger vein authentication system can save the operator the trouble of inputting a password or a password number.

In Patent Document 2, an imaging equipment formed integrally with a light source is disclosed. This imaging equipment has a structure in which a detection element array is disposed on a display to sandwich the detection element array between a photogenic subject and the display and elements of the detection element array and elements of the display are arranged alternately to allow light to pass through between the elements of the detection element array.

In Patent Document 3 as well, an imaging equipment formed integrally with a light source is disclosed. This imaging equipment has a light emission unit layer provided on a detection element substrate.
Patent Document 1: JP-A-2009-3821
Patent Document 2: JP-A-2005-276030
Patent Document 3: JP-A-5-14620

### SUMMARY OF THE INVENTION

In an apparatus in which operation is conducted by touching a touch panel device, it is authenticated whether operation is permitted. For example, since expert knowledge or specific authority becomes necessary in plant monitoring and operation, it is necessary to authenticate whether an operator who has conducted the operation is a regular operator. However, the conventional technique is not sufficient in authentication of operation which is input to the touch panel device.

For example, if it is necessary to subject to authentication and perform login whenever conducting the plant monitoring and operation, then authentication processing for login takes time and consequently a hindrance is constituted to regular monitoring or momentary operation. For example, the operator is forced to touch the imaging window for authentication with a finger whenever conducting operation, resulting in a burden upon the operator.

Making subsequent operations valid for a long time after login is performed once poses a problem in security. Because in a situation in which a plurality of persons use the same monitoring and operation screen at irregular intervals, an actual operator after the login might be different from the authenticated operator at the time of login. In that case, operation input from an unauthenticated operator is falsely validated, resulting in a problem in security.

Therefore, an object of the present invention is to solve the above-described problems and attain conducting operation input to the touch panel device fast with high security.

In order to attain the object, the present invention provides an operation processing system for processing an operation which is input by an operator who pushes a screen of a touch panel device with a finger, the touch panel device displaying operation objects on the screen and imaging the operator's finger which pushes the screen,

wherein the operation processing system comprises a point detection part, an authentication part, a database for authentication, an operation processing part, and a control table of operation authentication,

wherein the database for authentication stores finger feature information of at least one operator permitted to operate therein every operator,

the control table of operation authentication stores, for each of the operation objects displayed on the screen of the touch panel device, an operation content which is output by pushing the operation object, in association with the operation object,

the point detection part detects position information of a finger area on the screen where the operator's finger touches a touch panel on the basis of a pushing point of the operator's finger on the screen of the touch panel device, and transmits the position information to the touch panel device,

upon receiving finger image data imaged by the touch panel device with the position information of the finger area detected by the point detection part taken as an imaging range from the touch panel device, the authentication part collates feature information of the received finger image data with feature information of persons permitted to operate stored in the database for authentication, and thereby authenticates the received finger image data, and

when the authentication conducted by the authentication part has succeeded, the operation processing part acquires an operation to the operation object located in position information detected by the point detection unit from the control table of operation authentication and outputs the operation.

Other means will be described later.

According to the present invention, operation inputting to the touch panel device fast with high security can be attained.

Other objects, features and advantages of the invention will become apparent from the following description of the embodiments of the invention taken in conjunction with the accompanying drawings.

### BRIEF DESCRIPTION OF THE DRAWINGS

FIG. 1 is a configuration diagram showing a plant control system according to an embodiment of the present invention;

FIGS. 2A and 2B are configuration diagrams showing a touch panel device in a plant control system according to an embodiment of the present invention; and

FIG. 3 is a flow chart showing operation of a plant control system according to an embodiment of the present invention.

### DESCRIPTION OF THE EMBODIMENTS

Hereafter, an embodiment of the present invention will be described in detail with reference to the drawings.

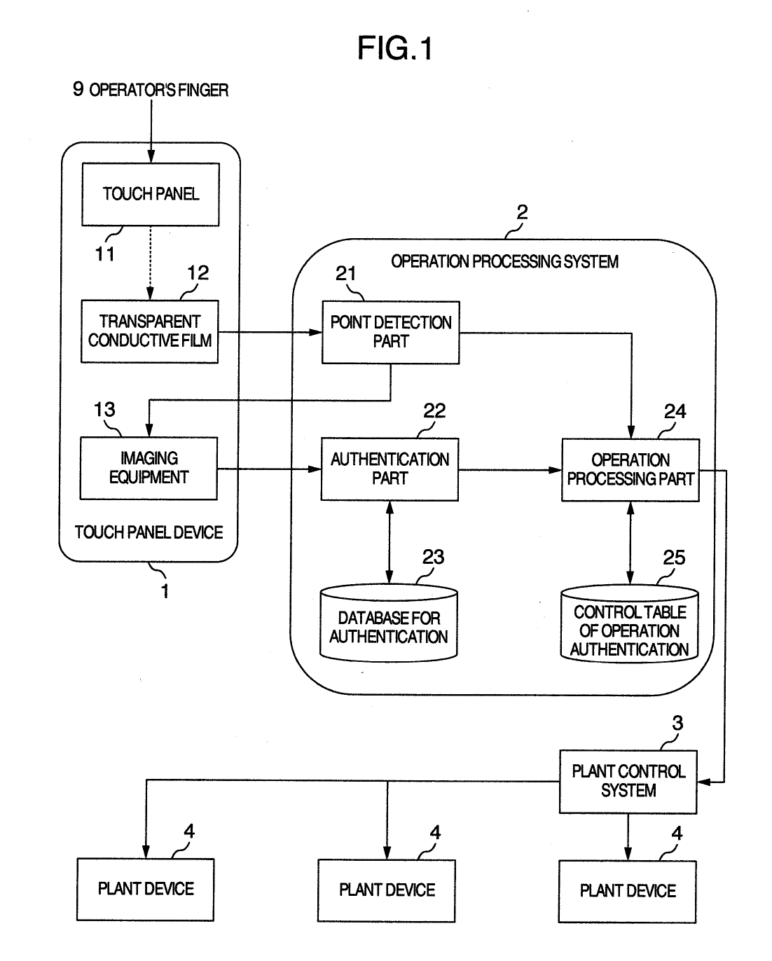

FIG. 1 is a configuration diagram showing a plant control system. The plant control system is formed by connecting a touch panel device 1, an operation processing system 2, a plant control system 3, and plant devices 4. Each of these apparatuses such as the systems and devices is configured as a computer including a CPU, a memory and a network interface. The CPU reads a program into the memory and executes the program. As a result, each of the processing parts described hereafter is attained.

In response to pushing with an operator's finger 9, the touch panel device 1 accepts operation input to the plant device 4 for deciding control signals. The touch panel device 1 includes a touch panel 11, a transparent conductive film 12 and an imaging equipment 13.

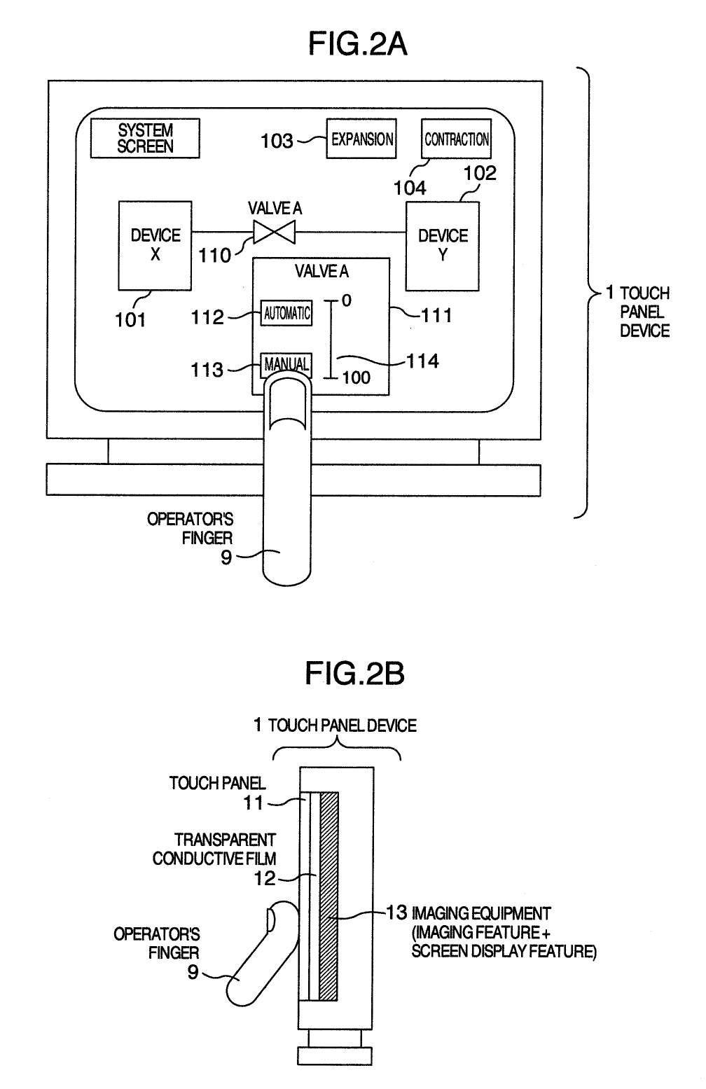

A configuration in which the touch panel device 1 is provided with both a screen display function of displaying a screen of the touch panel 11 and a function of imaging a finger which has touched the screen is described in, for example, patent application publication 2008-523460. By the way, an example of a physical configuration of the touch panel device 1 will be described with reference to FIGS. 2A and 2B.

The plant devices 4 are devices included in a plant such as valves.

The plant control system 3 outputs control signals (for example, control signals for closing a valve) to a plant device 4 and receives plant data which is output by a plant device 4. The touch panel device 1 causes the operator to confirm the states of the plant devices visually by displaying plant data which are output by the plant devices 4.

The operation processing system 2 includes a point detection part 21, an authentication part 22, a database for authentication 23, an operation processing part 24 and a control table of operation authentication 25. By the way, a part or all of the components in the operation processing system 2 may be included in other apparatuses such as the touch panel device 1 and the plant control system 3.

The point detection part 21 detects position information of an area (hereafter referred to as finger area) on the screen where a operator's finger 9 touches the touch panel 11 on the basis of a position in which the operator's finger 9 pushes the transparent conductive film 12. The point detection part 21 causes the operation processing part 24 to specify operation contents which has been input by the operator's finger 9 by notifying the operation processing part 24 of the detected finger area. The point detection part 21 notifies an imaging feature in the imaging equipment 13 of the detected finger area and thereby activates light sources corresponding to the finger area and causes the operator's finger 9 to be imaged for authentication.

With respect to positions on the screen which are input from the operator's finger 9, the point detection part 21 detects a position of a point which becomes a maximum point of change. On the other hand, the imaging equipment 13 needs to acquire an area position (surface position) of the operator's finger 9 on the screen in order to imaging a fingerprint of the operator's finger 9.

Therefore, the operation processing system 2 executes processing of specifying an area position of the operator's finger 9 on the basis of the point position of the operator's finger 9. As for this specifying processing, for example, an area corresponding to a size of a human finger, which is predetermined as a statistic value or registered for each operator, around the point position of the operator's finger 9 may be captured, or an area position of the operator's finger 9 may be captured from image data imaged by the imaging equipment 13 around the point position of the operator's finger 9 by using image acknowledgment processing. As for the image acknowledgment processing, for example, a technique of capturing an image area having color information similar to color information in the point position of the operator's finger 9 can be mentioned.

Upon receiving fingerprint data as a result of imaging from the imaging equipment 13, the authentication part 22 authenticates the fingerprint data and outputs a result of the authentication to the operation processing part 24. In the authentication processing, the received fingerprint data is used as a retrieval key to conduct retrieval in the database for authentication 23 and decide whether the fingerprint data is registered beforehand, and authentication is permitted if the fingerprint data is registered beforehand.

Therefore, the authentication part 22 generates a digital image of finger information from the imaging result of the imaging equipment 13, executes signal processing on the digital image, thereby acquires feature information of the finger information, and compares the feature information with feature information of finger information of every regular operator (maintenance engineer or manager) registered in the database for authentication beforehand.

TABLE 1
25 CONTROL TABLE OF OPERATION AUTHENTICATION

| | Whether authentication | | | |
|---|---|---|---|---|
| Operation object | is required | Operation authority | Screen operation output | Device operation output |
| Device X icon | ∘ Required | Manager | Change display color of | Turn off power supply of |
| | | | device X icon to gray | device X |
| Device Y icon | ∘ Required | Manager | Change display color of | Turn off power supply of |
| | | | device Y icon to gray | device Y |
| Screen expansion | x Not required | — | Expand screen | |
| button | | | | |
| Screen contraction | x Not required | — | Contract screen | |
| button | | | | |
| Valve A icon | ∘ Required | Maintenance engineer | Open valve A operation | |
| | | and manager | window | |
| Valve A operation | ∘ Required | Maintenance engineer | Invalidate valve A operation | Automatically adjust output |
| window automatic | | and manager | window slide bar | of valve A |
| button | | | | |
| Valve A operation | ∘ Required | Maintenance engineer | Validate valve A operation | Validate manual adjustment |
| window manual | | and manager | window slide bar | of output of valve A |
| button | | | | |
| Valve A operation | ∘ Required | Maintenance engineer | | Set output of valve A to |
| window slide bar | | and manager | | predetermined value |

The control table of operation authentication 25 associates “operation object” displayed on the screen of the touch panel device 1, “whether authentication is required” which indicates whether authentication is required to operate the operation object, “operation authority” which indicates authority to be permitted to conduct the operation, “screen operation output” reflected onto the screen of the touch panel device 1 as a result of the operation, and “device operation output” which is output to the plant devices 4 via the plant control system 3.

For example, a row of “device X icon” in the first row indicates a policy “operation on the device X icon needs authentication, operation conducted by an operator who is judged to be a manager by the authentication is permitted, and the operation causes control signals to be output to change a display color of the device X icon on the screen to gray and turn off the power supply of the device X.”

The operation processing part 24 decides whether operation is possible in accordance with the control table of operation authentication 25, and outputs contents of a permitted operation to the plant devices 4 via the plant control system 3.

For that purpose, the operation processing part 24 first specifies an operation object described in the column of “operation object” in the control table of operation authentication 25 on the basis of operation position information acquired from the point detection part 21. This operation object specifying processing can be attained by, for example, storing correspondence information of IDs of operation objects and position information of figures of the operation objects in a storage part beforehand and retrieving position information of a figure located in operation position information from the correspondence information. And the operation processing part 24 decides whether to permit the operation on the operation object, on the basis of the authentication result acquired from the authentication part 22.

Hereafter, an example of a policy of decision processing for deciding whether to permit the operation conducted by the operation processing part 24 will be described.

Procedure (1): If “whether authentication is required” in the control table of operation authentication 25 is “x not required”, then the operation is permitted regardless of the contents of the authentication result.

Procedure (2): If “whether authentication is required” in the control table of operation authentication 25 is “∘ required” and “operation authority” is not set, then the operation is permitted when the operator conforms to an arbitrary operator registered in the database for authentication 23 beforehand, as an authentication result. Procedure (3): If “whether authentication is required” in the control table of operation authentication 25 is “∘ required” and “operation authority” is set, then the operation is permitted when authority of an operator specified from the database for authentication 23 is included in “operation authority” in the control table of operation authentication 25, as an authentication result.

Procedure (4): If any of the procedures (1) to (3) is not conformed to, then the operation is not permitted. By the way, when the operation is not permitted, the event of operation may be canceled after the fact that the operation is not permitted and its cause (the operator does not have operation authority or the operator is not registered as an operator) are displayed on the screen.

FIG. 2A shows a front view of the touch panel device 1.

In the touch panel device 1, a device X icon 101, a device Y icon 102, a screen expansion button 103, a screen contraction button 104, a valve A icon 110, a valve operation window 111, an automatic button 112, a manual button 113 and a slide bar 114 are displayed as figures of operation objects to be pushed by the operator's finger 9. Figures of these operation objects are registered in the control table of operation authentication 25. For example, the device X icon 101 corresponds to “device X icon” in the first row in the control table of operation authentication 25.

By the way, FIG. 2A shows a state in the moment the operator's finger 9 has pushed the manual button 113 in the valve A operation window 111.

FIG. 2B shows a side view of the touch panel device 1. The touch panel device 1 is formed by stacking the touch panel 11, the transparent conductive film 12 and the imaging equipment 13 in order from a top layer which is close to the operator's finger 9.

The touch panel 11 is a panel directly touched by the operator's finger 9. The transparent conductive film 12 is installed as a two-layer transparent conductive film 12 (an X layer and a Y layer) having silver on electrodes on a stationary (glass) substrate of the imaging equipment 13. A top layer of the touch panel 11 has sufficient flexibility. When the surface of the top layer of the touch panel 11 is pressed, the part makes a dent so as to cause the two layers of the transparent conductive film 12 to come in contact with each other.

In other words, if the operator's finger 9 presses the surface (the top layer) of the touch panel 11, the two layers of the transparent conductive film 12 come in contact with each other. Thereupon, a current flows via silver paste electrodes located at both ends of the transparent conductive film 12, and a pushing point of the operator's finger 9 is detected by monitoring a voltage value generated at that time by utilizing an A/D converter.

By the way, the touch panel device 1 is attained as a resistance film method using the transparent conductive film 12. On the other hand, other attainment methods of the touch panel such as the surface elastic wave method, infrared method and electric capacity method may be used instead of the resistance film method.

The imaging equipment 13 has a configuration in which an imaging feature including light sources and sensors and a screen display feature are provided in the same casing. The imaging equipment 13 is specifically configured as, for example, the imaging equipment described in Patent Document 1. The screen display feature displays a plant state on the touch panel device 1 by acquiring plant data from the plant control system 3 periodically and coupling the plant data with screen display information such as a plant system diagram.

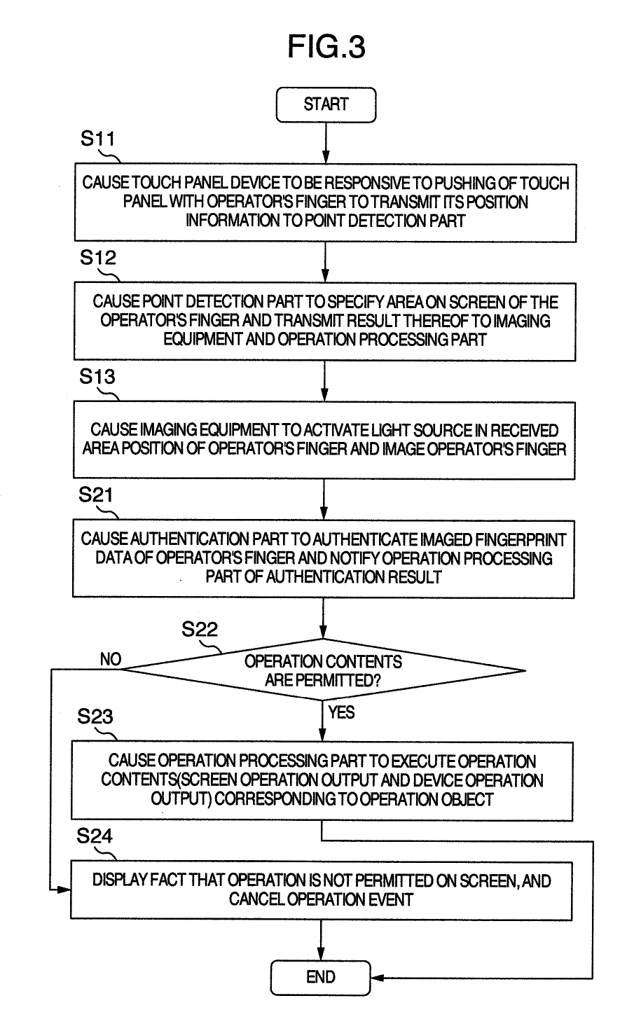

FIG. 3 is a flow chart showing behavior of the plant control system.

As S11, the touch panel 11 and the transparent conductive film 12 in the touch panel device 1 is responsive to pushing with the operator's finger 9 to transmit its position information to the point detection part 21. If the pushing point of the operator's finger 9 is not a position of an operation object registered in the control table of operation authentication 25, then the pushing is not operation and consequently the pushing may be ignored.

As S12, the point detection part 21 specifies an area on the screen of the operator's finger 9 on the basis of the pushing point received from the touch panel device 1 at S11, and transmits a result thereof to the imaging equipment 13 and the operation processing part 24.

As S13, the imaging feature in the imaging equipment 13 activates a light source in the area position of the operator's finger 9 received at S12 and images the operator's finger 9. Finger information can be acquired in an arbitrary position on the screen by setting an area where a light source is activated as the area position of the operator's finger 9. And the imaging equipment 13 transmits fingerprint data of the operator's finger 9 which is a result of the imaging to the authentication part 22.

As S21, the authentication part 22 authenticates the operator by retrieving fingerprint data of the operator's finger 9 received at S13, from the database for authentication 23. And the authentication part 22 notifies the operation processing part 24 of a result of the authentication.

Specifically, first, the authentication part 22 captures only a finger part from contour of a finger vein image, and generates an image of a space frequency content required for the finger veins, from an image of the finger part obtained as a result of the capture. Then, the authentication part 22 conducts position adjustment on the generated image, and corrects a difference in angle or position. And the authentication part 22 extracts only information of finger veins used in personal authentication, from the corrected image.

And the authentication part 22 regards the extracted information of the finger veins as feature information, and compares the feature information with feature information registered previously in the database for authentication 23. As a result, the authentication part 22 decides whether an operator who has pushed with the finger at S11 is a registered regular operator, and specifies operation authority given to the regular operator.

As S22, the operation processing part 24 refers to the control table of operation authentication 25 on the basis of the authentication result received at S21, and decides whether to permit operation contents notified of at S12. If the operation contents are permitted, the processing proceeds to S23. If the operation contents are not permitted, the processing proceeds to S24.

As S23, the operation processing part 24 retrieves an operation object located in the position 9 of the operator specified at S12, from the control table of operation authentication 25, and executes corresponding operation contents (the screen operation output and the device operation output).

As S24, the fact that operation is impossible is displayed on the screen, and the event of operation is canceled.

In the behavior of the plant control system described heretofore, authentication and operation output are conducted every input operation and consequently login processing of the operator can be made unnecessary and quick operation can be attained. The behavior of the plant control system is, so to speak, (state-less) processing in which state management judging whether the state is that during login is not conducted.

On the other hand, the state-less processing shown in FIG. 3 may be combined with (state-full) processing for managing the login state. For example, the operation processing system 2 may execute state management which causes transition to following two states (1) and (2).

The state (1) is an operation prohibition state which corresponds to a state before login. If a position other than positions of figures which represent operation objects displayed on the touch panel device 1 is detected or a body (such as an operation pen) other than a finger touches the screen of the touch panel device 1, then the point detection part 21 discards the detected position information without notifying other processing parts of the detected position information. Upon detecting a position of a figure which represents an operation object displayed on the touch panel device 1, the point detection part 21 notifies the imaging equipment 13 of the detected position information and thereby causes the authentication part 22 to execute authentication of the operator's finger 9 imaged by the imaging equipment 13. Upon success of the authentication, the authentication part 22 makes a transition to the state (2).

The state (2) is an operation permission state which corresponds to the state after the login. The point detection part 21 detects that the screen of the touch panel device 1 is pushed in an arbitrary position displayed thereon with an arbitrary body (which includes bodies other than a finger), and notifies other processing parts of the detected position information to cause detected operation contents to be output. The operation processing system 2 makes a transition to the state (1) with a predetermined event (such as power supply resetting) or a fact that authentication of the operator's finger 9 has not succeeded in a predetermined time as a momentum.

In the plant control system described heretofore, the authentication part 22 conducts authentication every pushing with the operator's finger 9 and consequently pushing with the operator's finger 9 once serves as both inputting for authentication and inputting for operation. As compared with the method in which login is conducted by authentication inputting and then inputting for operation is conducted, therefore, the input speed of the operator can be improved. In addition, even when there are a plurality of operators, operation outputting with a high security strength is made possible by permitting operations corresponding to authorities of the operators.

The present embodiment has been described by taking the plant control system having a plant (the plant control system 3 and the plant devices 4) as the operation object as an example. However, the touch panel device 1 and the operation processing system 2 may be used for operation inputting to an arbitrary system. For example, the operation processing system 2 may be used as a user interface of a cash processing apparatus such as an ATM (Automatic Teller Machine). As a result, authentication can be conducted by taking an operation as the unit. Therefore, illegal operation conducted by an illegal user after login conducted by a regular user can be suppressed.

The operation processing system 2 may decide whether to permit operation by combining authentication processing of the operator's finger 9 conducted by the authentication part 22 with the principal confirmation processing using an IC card or the like. For example, when an IC card is inserted into the operation processing system 2 and authentication of principal authentication data written into the IC card has succeeded, control is exercised to omit the authentication processing to be conducted by the authentication part 22 and regard all operation inputs as those supplied from an operator corresponding to the principal authentication data.

Operation authority of the operator is listed in the control table of operation authentication 25. However, an operation which differs every operation authority of the operator obtained as the result of the authentication conducted by the authentication part 22 may be output when the same operation object is touched.

For example, in the control table of operation authentication 25, operation authority of the operation object “valve A icon” is given to the “maintenance engineer and manager” and “open valve A operation window” is defined in the screen operation output.

It is supposed that the control table of operation authentication 25 is defined for the operation object “valve A icon” so as to yield “open valve A operation window” as the screen operation output when the “maintenance engineer” has operated and yield “open valve A information window” as the screen operation output when the “manager” has operated. In this case, an operation output according to the operation authority can be executed even for the same operation.

It should be further understood by those skilled in the art that although the foregoing description has been made on embodiments of the invention, the invention is not limited thereto and various changes and modifications may be made without departing from the spirit of the invention and the scope of the appended claims.

1. An operation processing system for processing an operation which is input by an operator who pushes a screen of a touch panel device with a finger, the touch panel device displaying operation objects on the screen and imaging the operator's finger which pushes the screen, the operation processing system comprising:
a point detection part;
an authentication part;
a database for authentication;
an operation processing part; and
a control table of operation authentication,
wherein
the database for authentication stores finger feature information of at least one operator permitted to operate therein every operator,
the control table of operation authentication stores, for each of the operation objects displayed on the screen of the touch panel device, an operation content which is output by pushing the operation object, in association with the operation object,
the point detection part detects position information of a finger area on the screen where the operator's finger touches a touch panel on the basis of a pushing point of the operator's finger on the screen of the touch panel device, and transmits the position information to the touch panel device,
upon receiving finger image data imaged by the touch panel device with the position information of the finger area detected by the point detection part taken as an imaging range from the touch panel device, the authentication part collates feature information of the received finger image data with feature information of persons permitted to operate stored in the database for authentication, and thereby authenticates the received finger image data, and
when the authentication conducted by the authentication part has succeeded, the operation processing part acquires an operation to the operation object located in position information detected by the point detection unit from the control table of operation authentication and outputs the operation.

2. The operation processing system according to claim 1, wherein the authentication part uses information of finger veins as feature information of the operator's finger to be collated for authentication.

3. The operation processing system according to claim 1, wherein
in the control table of operation authentication, information which indicates whether authentication is required is associated with each of the operation objects, and
when an operation object associated with “authentication is not required” in the control table of operation authentication is pushed, the operation processing part acquires an operation to the operation object from the control table of operation authentication and outputs the operation regardless of a result of the authentication conducted by the authentication part.

4. The operation processing system according to claim 2, wherein
in the control table of operation authentication, information which indicates whether authentication is required is associated with each of the operation objects, and
when an operation object associated with “authentication is not required” in the control table of operation authentication is pushed, the operation processing part acquires an operation to the operation object from the control table of operation authentication and outputs the operation regardless of a result of the authentication conducted by the authentication part.

5. The operation processing system according to claim 1, wherein
in the control table of operation authentication, information which indicates operation authority is associated with each of the operation objects, and
if the operation processing part receives an authentication result which specifies operation authority of an operator with respect to a predetermined operation object and the predetermined operation object and operation authority thereof are associated with each other in the control table of operation authentication, then the operation processing part acquires operation to the operation object from the control table of operation authentication and outputs the operation.

6. The operation processing system according to claim 2, wherein
in the control table of operation authentication, information which indicates operation authority is associated with each of the operation objects, and
if the operation processing part receives an authentication result which specifies operation authority of an operator with respect to a predetermined operation object and the predetermined operation object and operation authority thereof are associated with each other in the control table of operation authentication, then the operation processing part acquires operation to the operation object from the control table of operation authentication and outputs the operation.

7. The operation processing system according to claim 1, wherein
the operation processing system further manages a current system state as either an operation prohibition state or an operation permission state,
in the operation prohibition state, the operation processing system prohibits the operation processing part from outputting an operation,
in the operation permission state, the operation processing system prohibits the operation processing part to output an operation, and
if authentication conducted by the authentication part has succeeded in the operation prohibition state, then the operation processing system makes a transition to the operation permission state.

8. The operation processing system according to claim 2, wherein
the operation processing system further manages a current system state as either an operation prohibition state or an operation permission state,
in the operation prohibition state, the operation processing system prohibits the operation processing part from outputting an operation,
in the operation permission state, the operation processing system prohibits the operation processing part to output an operation, and
if authentication conducted by the authentication part has succeeded in the operation prohibition state, then the operation processing system makes a transition to the operation permission state.

9. The operation processing system according to claim 1, wherein
when an operation is not output from the operation processing part because of a failure of authentication in the authentication part although pushing with an operator's finger is conducted on the touch panel device, the operation processing system displays a notice to the effect that the operation has been canceled on the screen of the touch panel device.

10. The operation processing system according to claim 2, wherein
when an operation is not output from the operation processing part because of a failure of authentication in the authentication part although pushing with an operator's finger is conducted on the touch panel device, the operation processing system displays a notice to the effect that the operation has been canceled on the screen of the touch panel device.

11. An operation processing method which uses an operation processing system for processing an operation which is input by an operator who pushes a screen of a touch panel device with a finger, the touch panel device displaying operation objects on the screen and imaging the operator's finger which pushes the screen, the operation processing system comprising:
a point detection part;
an authentication part;
a database for authentication;
an operation processing part; and
a control table of operation authentication,
wherein
the database for authentication stores finger feature information of at least one operator permitted to operate therein every operator,
the control table of operation authentication stores, for each of the operation objects displayed on the screen of the touch panel device, an operation content which is output by pushing the operation object, in association with the operation object,
the point detection part detects position information of a finger area on the screen where the operator's finger touches a touch panel on the basis of a pushing point of the operator's finger on the screen of the touch panel device, and transmits the position information to the touch panel device,
upon receiving finger image data imaged by the touch panel device with the position information of the finger area detected by the point detection part taken as an imaging range form the touch panel device, the authentication part collates feature information of the received finger image data with feature information of persons permitted to operate stored in the database for authentication, and thereby authenticates the received finger image data, and
when the authentication conducted by the authentication part has succeeded, the operation processing part acquires an operation to the operation object located in position information detected by the point detection unit from the control table of operation authentication and outputs the operation.

12. An operation processing program for causing the operation processing system which is a computer, to execute the operation processing method described in claim 11.

13. The operation processing system according to claim 3, wherein
in the control table of operation authentication, information which indicates operation authority is associated with each of the operation objects, and
if the operation processing part receives an authentication result which specifies operation authority of an operator with respect to a predetermined operation object and the predetermined operation object and operation authority thereof are associated with each other in the control table of operation authentication, then the operation processing part acquires operation to the operation object from the control table of operation authentication and outputs the operation.

14. The operation processing system according to claim 4, wherein
in the control table of operation authentication, information which indicates operation authority is associated with each of the operation objects, and
if the operation processing part receives an authentication result which specifies operation authority of an operator with respect to a predetermined operation object and the predetermined operation object and operation authority thereof are associated with each other in the control table of operation authentication, then the operation processing part acquires operation to the operation object from the control table of operation authentication and outputs the operation.

15. The operation processing system according to claim 3, wherein
the operation processing system further manages a current system state as either an operation prohibition state or an operation permission state,
in the operation prohibition state, the operation processing system prohibits the operation processing part from outputting an operation,
in the operation permission state, the operation processing system prohibits the operation processing part to output an operation, and
if authentication conducted by the authentication part has succeeded in the operation prohibition state, then the operation processing system makes a transition to the operation permission state.

16. The operation processing system according to claim 4, wherein
the operation processing system further manages a current system state as either an operation prohibition state or an operation permission state,
in the operation prohibition state, the operation processing system prohibits the operation processing part from outputting an operation,
in the operation permission state, the operation processing system prohibits the operation processing part to output an operation, and
if authentication conducted by the authentication part has succeeded in the operation prohibition state, then the operation processing system makes a transition to the operation permission state.

17. The operation processing system according to claim 5, wherein
the operation processing system further manages a current system state as either an operation prohibition state or an operation permission state,
in the operation prohibition state, the operation processing system prohibits the operation processing part from outputting an operation,
in the operation permission state, the operation processing system prohibits the operation processing part to output an operation, and
if authentication conducted by the authentication part has succeeded in the operation prohibition state, then the operation processing system makes a transition to the operation permission state.

18. The operation processing system according to claim 6, wherein
the operation processing system further manages a current system state as either an operation prohibition state or an operation permission state,
in the operation prohibition state, the operation processing system prohibits the operation processing part from outputting an operation,
in the operation permission state, the operation processing system prohibits the operation processing part to output an operation, and
if authentication conducted by the authentication part has succeeded in the operation prohibition state, then the operation processing system makes a transition to the operation permission state.

19. The operation processing system according to claim 3, wherein
when an operation is not output from the operation processing part because of a failure of authentication in the authentication part although pushing with an operator's finger is conducted on the touch panel device, the operation processing system displays a notice to the effect that the operation has been canceled on the screen of the touch panel device.

20. The operation processing system according to claim 4, wherein
when an operation is not output from the operation processing part because of a failure of authentication in the authentication part although pushing with an operator's finger is conducted on the touch panel device, the operation processing system displays a notice to the effect that the operation has been canceled on the screen of the touch panel device.

21. The operation processing system according to claim 5, wherein
when an operation is not output from the operation processing part because of a failure of authentication in the authentication part although pushing with an operator's finger is conducted on the touch panel device, the operation processing system displays a notice to the effect that the operation has been canceled on the screen of the touch panel device.

22. The operation processing system according to claim 6, wherein
when an operation is not output from the operation processing part because of a failure of authentication in the authentication part although pushing with an operator's finger is conducted on the touch panel device, the operation processing system displays a notice to the effect that the operation has been canceled on the screen of the touch panel device.

23. The operation processing system according to claim 7, wherein
when an operation is not output from the operation processing part because of a failure of authentication in the authentication part although pushing with an operator's finger is conducted on the touch panel device, the operation processing system displays a notice to the effect that the operation has been canceled on the screen of the touch panel device.

24. The operation processing system according to claim 8, wherein
when an operation is not output from the operation processing part because of a failure of authentication in the authentication part although pushing with an operator's finger is conducted on the touch panel device, the operation processing system displays a notice to the effect that the operation has been canceled on the screen of the touch panel device.
